(19) United States
(12) Patent Application Publication
(10) Pub. No.: US 2020/0286027 A1
(43) Pub. Date: Sep. 10, 2020

(54) SYSTEM AND METHODS FOR LAST MILE DELIVERY OF GOODS

(71) Applicant: SAMIR HANNA SAFAR, SAN DIEGO, CA (US)

(72) Inventor: SAMIR HANNA SAFAR, SAN DIEGO, CA (US)

(21) Appl. No.: 16/297,706

(22) Filed: Mar. 10, 2019

(51) Int. Cl. G06Q 10/08; G06N 5/04; G06N 20/00

(52) U.S. Cl. CPC G06Q 10/083; G06N 20/00; G06N 5/04; G06Q 10/0833

(57) ABSTRACT

A system and methods for efficient and quick last mile delivery of goods are provided. The system includes several authorized geographically pre-designated spiders, registered with one or more shipping companies, each spider having one or more sub-spiders and capable of operating an authorized staging unit and in communication with a shipping company through a smart phone app. The shipping company approves the staging unit of the spider, thereby the spider is located at a predefined location and pre-designated time, the shipping company delivers goods/parcels to the spider via carrier trucks, and the spider delivers goods to pre-specified locations on a dynamically configured geographical route. by means of own vehicle, or delivery robots, or drones and updates the status of deliveries and pick up in real time through the smart phone app. Artificial Intelligence based self learning inputs are used to anticipate the optimum route and location of the spider.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC Not Applicable

### FIELD OF THE INVENTION

The present invention belongs to the field of logistics and shipping, and more particularly relates to novel system and methods for quick and efficient last mile delivery of goods to a specified customer location.

### BACKGROUND OF THE INVENTION

With the advent of online shopping through e-commerce, there has been a sharp rise in the requirement of delivering goods to a pre-specified customer location. There are also many occasions when an unsatisfied customer wishes to return the goods back, and these goods need to be picked up from the specific customer location. Delivery of the shipped goods may also involve processing of monetary transactions, and a record of proof of delivery. Logistics service providers are often required to deliver single packages to high and low-density areas, and yet customers are demanding and expecting faster and cheaper deliveries.

Evolving the last mile delivery to the customer, and making it more than a Just Leave On Porch (JLOP) delivery experience is a priority area for many internet retail organizations such as Amazon. Many improvements are being attempted in the areas of delivery hub management, route planning and optimization, driver devices, processing of returns and reverse logistics.

In a review article published in Sustainability 2018, 10, 782, titled “A Review of Last Mile Logistics Innovations in an Externalities Cost Reduction Vision”, it is stated that in the last mile delivery, the most widespread transport mode adopted is road. In urban areas, road freight transport is the major mode responsible for the externalities related to the delivery. Last mile delivery represents a significant problem for the generated traffic volume in the urban area. Usually, it is fragmented and uncoordinated: shippers engage different logistics service providers and carriers for the delivery to the retailers in the cities. This produces a low load factor of vehicles, a large number of routes, high externalities and wide system costs. Last mile logistics is the least efficient stage of the supply chain and comprises up to 28% of the total delivery cost.

As a result several solutions have been attempted to address this section of the logistics. Below are given some of the known prior art.

U.S. Pat. No. 7,761,348 titled “Systems and methods for consolidated global shipping” discloses an integrated global shipment system that provides end-to-end visibility of the movement of a package. The integrated global shipment system employs a shipment consolidating application for integrating one or more freight tracking systems with one or more end-delivery systems. As a result, shippers are provided with complete visibility of the movement of their shipments of goods from an origin country to a destination country and till the final consignees. In addition, the integrated shipment system significantly decreases the cost of managing inventories by providing a virtual inventory solution. Under this virtual inventory solution, suppliers are able to bypass distribution centers and delay allocation of goods until after the importation of goods into a destination country.

U.S. Pat. No. 8,744,977 titled “Method and system for anticipatory package shipping” describes a method that includes packaging one or more items as a package for eventual shipment to a delivery address, selecting a destination geographical area to which to ship the package, shipping the package to the destination geographical area without completely specifying the delivery address at time of shipment, and while the package is in transit, completely specifying the delivery address for the package.

Current trends include using drones and unmanned aerial vehicles for fast and efficient means to deliver goods.

Despite various improvements and progress in the field, some of the major obstacles that still exist are presented herein below. The existing methods are unable to overcome the challenge of using large vehicles such as delivery trucks to continuously go around, making frequent stoppages for short distances and burdening the driver. The shipping companies are required to maintain a fleet of delivery vehicles and have to bear the additional costs pertaining to operation and maintenance of these delivery vehicles besides the associated manpower costs. Besides the existing methods are time consuming and inefficient. Accordingly, improvements are needed in the existing devices that negate the above shortcomings.

It is observed that the purpose and methodology of all the above inventions that are part of prior art do not envisage the unique embodiment of a system and methods for efficient and quick last mile delivery of goods to pre-specified locations, as described in the present application.

The scope of the invention is to be determined by the terminology of the following description, claims, drawings and the legal equivalents thereof.

### SUMMARY OF THE INVENTION

The present invention may be summarized, at least in part, with reference to its objectives.

It is therefore a primary objective of the present invention to provide a system and methods for efficient and quick last mile delivery of goods to pre-specified locations.

Another objective of the present invention is to provide a system and methods for efficient and quick last mile pick up of goods from pre-specified locations.

Yet another objective is to provide a system that reduces the travel time and effort of delivery trucks in a limited area throughout the day, with frequent stoppages.

Another objective of the present invention is to provide an efficient system that can be used for delivery and pick up of goods from pre-specified addresses based on dynamic allocation of routes and expected delivery volume pattern.

A still further objective of the present invention is to reduce the costs for the shipping companies in terms of operating and maintaining a large fleet of delivery vehicles and the associated manpower costs.

Yet another objective of the present invention is to provide a higher level of customer satisfaction as a result of faster delivery of goods.

The invention described herein thus comprises a system for last mile delivery and pick-up of goods from pre-specified locations, using a network of authorized, geographically pre-designated, local delivery and pick-up agents (referred to as “spider” in this patent application). The shipping company approves a “staging unit” associated with a “spider web” (a pre-designated dynamically configured geographical route) to a spider as per the volume of shipment of goods to be delivered or picked up from a specific area. A staging unit functions as a logical distribution interface for easy assignment of delivery and pick up of goods from and to pre-specified locations.

The system in accordance with the present invention comprises: a plurality of authorized geographically pre-designated spiders, registered with one or more shipping companies, a plurality of sub-spiders associated with a given spider, an authorized staging unit corresponding to the registered spider, wherein the registered spider is in communication with a shipping company through a software application, the shipping company approves staging unit of the spider, thereby the spider is located at a predefined location and pre-designated time, the spider being associated with one pre-defined dynamically configured geographical route, the shipping company delivers goods/parcels to the spider via one or more carrier truck/vehicle of the shipping company, the spider delivers to pre-specified locations by means of own vehicle, or delivery robots, or drones, through the associated pre-defined dynamically configured route, and updates the status of deliveries and pick up of goods in real time through the software application.

The invention described herein thus comprises a method for last mile delivery and pick up of goods from pre-specified locations. The method comprising:
a) registering a spider on a shipping company network after successful validation
b) assigning a staging unit to a registered spider to a predefined location and pre-designated time based on business rules,
c) delivery or pick up of goods from/to a spider via one or more carrier truck/vehicle,
d) localized delivery or pick up of goods from/to addressee location by a spider's local means via one or more sub-spiders, and
e) updation of delivery and pick up status through a software application.

The above summary is intended to illustrate exemplary embodiments of the invention, which will be best understood in conjunction with the detailed description to follow, and are not intended to limit the scope of the invention. Additional objects and embodiments of the invention will be set forth in part in the description which follows, and in part will become apparent to those skilled in the art upon examination of the following, or may be learned by practice of the invention. Thus these and other objects of the present invention will be more readily apparent when considered in reference to the following description and when taken in conjunction with the accompanying drawings.

### DESCRIPTION OF THE DRAWINGS

FIG. 1 is an illustration depicting an embodiment of the present invention.

FIG. 2 is an illustration depicting a larger view of the present invention.

FIG. 3 is an illustration depicting in detail the staging unit component of the present invention.

FIG. 4 is an alternate embodiment of the present invention which employs artificial intelligence based inputs, shown as a flowchart.

FIG. 5 is an illustration representing an exemplary color coding scheme in the staging unit.

FIG. 6 is a flowchart depicting the functionality of the artificial intelligence based logic in an embodiment of the invention.

FIG. 7 is an illustration depicting an exemplary embodiment of the invention.

FIG. 8 is an illustration depicting a no destination address delivery system in an alternate embodiment of the invention.

FIG. 9 is an exemplary illustration flow chart depicting the sequence of steps in an embodiment of the invention.

FIG. 10 is an illustration depicting the information flow among various software modules included in an embodiment of the invention.

FIG. 11 is an illustration depicting the splitting of spider webs as per volume of deliveries in an embodiment of the invention.

FIG. 12 is an illustration depicting the adjustment of a spider web's geographical location according to Spider System AI prediction module in an embodiment of the invention.

FIG. 13 is an illustration depicting the Sling Spider in an alternate embodiment of the invention.

### DETAILED DESCRIPTION OF THE INVENTION

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

The following description is presented to enable any person skilled in the art to make and use the invention, and is provided in the context of particular applications of the invention and their requirements.

It is advantageous to define several terms, phrases and acronyms before describing the invention in detail. It should be appreciated that the following terms are used throughout this application. Where the definition of terms departs from the commonly used meaning of the term, applicant intends to utilize the definitions provided below, unless specifically indicated.

“Shipping company” denotes a distributor or a transportation agency, which offers carrier services for delivery of goods to customers. Representative examples may include United Parcel Service (UPS), FedEx, DHL and the United States Postal Service (USPS).

“Carrier” denotes a vehicle operated by the Shipping company.

“Spider” denotes an authorized, registered local agent for delivery and/or pick up of goods from the shipping company in a pre-specified geographical area.

“Spider web” denotes a network of localized transit routes or paths within a geographical area which covers a pre-specified region of addresses. It is to be noted that the spider web is not a fixed set of paths, but is dynamically configured and allocated/assigned to a Spider as per pre-defined and changeable business rules.

“Staging unit” denotes a logical local distribution interface for efficient management, segregation of delivery and pick up of goods. Each staging unit is managed by one spider, covering at least one spider web (preferably one spider web) depending on the volume of packages to be delivered. The spider operates the staging unit through a vehicle, such as for example a delivery truck or van, which may be owned or hired, or an autonomous vehicle.

“Sub-spider” denotes an authorized, registered local agent for delivery and/or pick up of goods from the spider in a pre-specified geographical area, smaller than the spider web.

“Sling-spider” denotes a spider meant for deliveries at office locations, or commercial spaces. Preferably the sling-spider has a working place at the same office location or commercial space. A sling-spider is assigned an office location or a commercial space, based on his/her proximity.

“Delivery robot” denotes robotic devices for automated local delivery of goods to pre-specified locations.

Described below are the software application systems which are used in the present invention, having specified functionalities. It is possible for these software applications to have their functional features combined or interchanged. The functionalities as associated with given software systems as described below are provided for better clarity. In alternate embodiments, these software systems may be provided as different software modules of the same system. The following definitions are therefore exemplary in nature and should not be construed as limiting the scope of the invention.

“Spider Software System” denotes an enterprise software application that comprises functionalities for database management, data warehousing, Spider App APIs, Spider App database, Spider Learning System. It is a fully integrated system with features for spider system website management, spider account, sub-spider, and sling spider registration and account management, spider payroll/earning processing, spider performance. This system interacts with an enterprise accounting software for all other accounting needs.

“Spider App” denotes a software application compatible with a smart device (such as for example, a smart phone, a tablet) configured to register a spider with a given shipping company for delivery/pick up of goods in a pre-designated spider web. The Spider App has several other functional modules such as for example, for registration of a spider, for assignment of a spider to a spider web, for configuration of a spider web, for prediction of spider web route for pick up of returned goods and generation of suitable transit routes based on artificial intelligence based learning (based on frequency and volume of past deliveries, for example), for management of staging units, for updation of latest status of delivery or pick up of goods. The Spider App is updated and fed information by the Spider Software System dynamically at all times. The functional features include modules for: Spider registration, Spider payment processing, Package delivery and pick up, Package tracking and processing within the Spider web, Carrier truck routes and movement within a Spider Web, Carrier package delivery and pickup from the staging units, performance data collection, scanning functions, printing shipping labels. It is integrated with autonomous delivery vehicles via the Spider Software System.

“Spider App learning system” denotes an Artificial Intelligence based subsystem within the Spider Software System. This system learns movements of carrier trucks, package delivery address, frequency based on historical data. It also does analysis, predictions and frequency of package delivery. It learns from the Carrier system the frequency of items that were delivered to a certain address or geographical areas. It also learns from online vendor how frequent a certain product gets delivered to a certain address or geographical areas.

“Carrier System” denotes an external carrier software system that is owned and operated by the carrier/shipping company. It shares the Spider Software System packages shipping/tracking truck delivery, truck routes, and movement via the Internet on an instantaneous basis, dynamically.

In a similar fashion, separate software application systems or modules may be provided for sub-spiders, delivery robots, sling spiders.

The invention described herein thus comprises an efficient, accurate, reliable and quick system (hereinafter referred to as “Spider Delivery System”) and efficient methods for delivery of goods from a shipping company to pre-specified locations. The present invention is described with reference to the drawings.

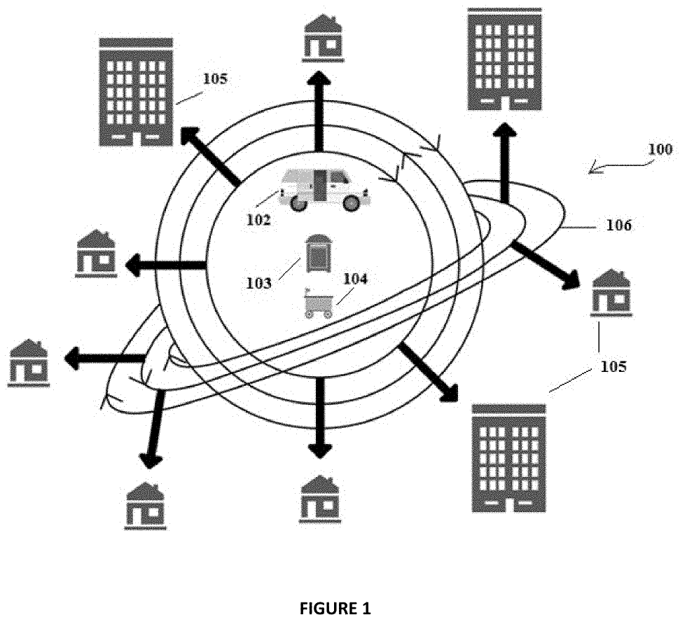

Referring to FIG. 1, 100 denotes a system for efficient, accurate, reliable and quick system (Spider Delivery System) for delivery of goods from a shipping company to pre-specified locations, such as 105. 102 denotes a spider operated staging unit. 103 denotes a brick and mortar locker, while 104 denotes a delivery robot. 106 denotes a spider web.

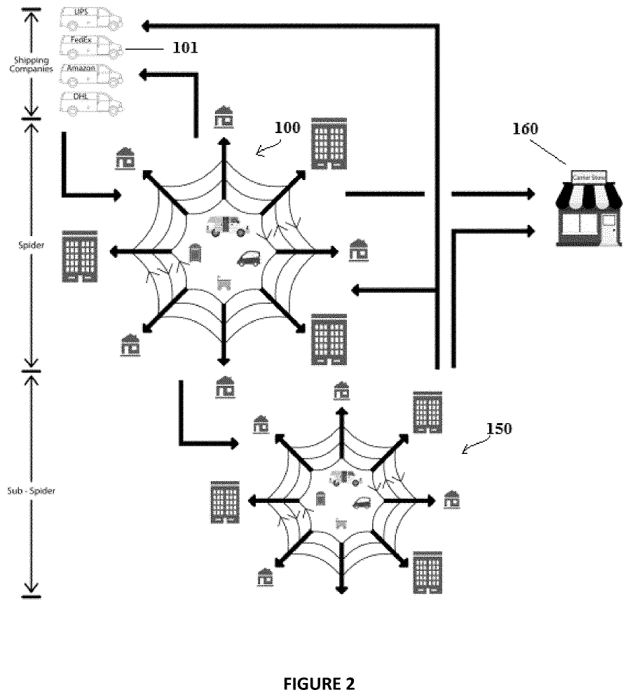

Referring to FIG. 2, wherein the present invention is illustrated in a larger perspective. Shipping companies 101 employ a Spider Delivery system 100, which may further employ a Sub-Spider based system 150 to deliver goods to pre-specified locations, which include but are not limited to residential addresses, commercial locations such as business, office, retail spaces, or carrier stores 160.

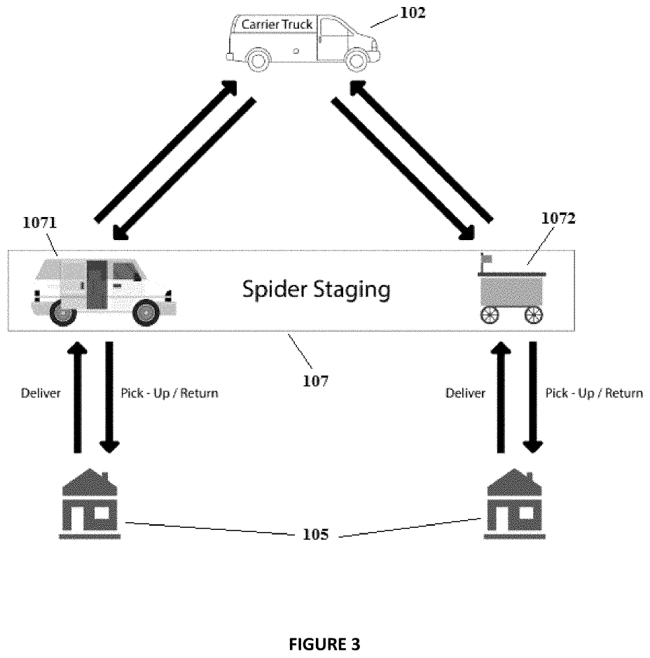

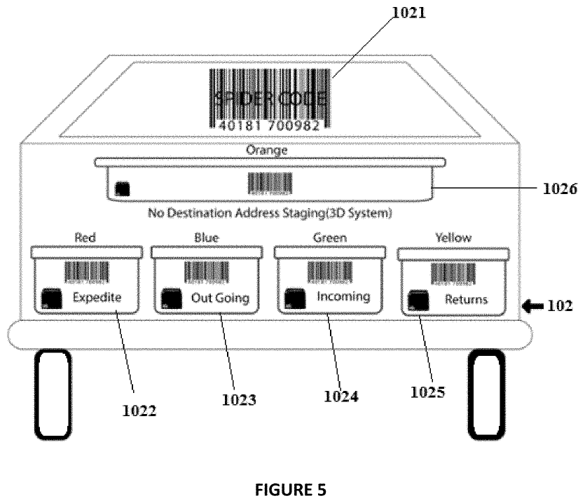

Referring to FIG. 3, which depicts an overview of the staging unit component of the Spider Delivery System. A spider operates a staging unit 107 from a carrier truck 102, which may be an owned vehicle or a hired vehicle. The staging unit 107 is used for selecting the best possible delivery option, such as an autonomous vehicle, the carrier truck or a delivery robot. This is achieved by way of Spider App based on pre-specified business rules, such as proximity to a delivery address, current location of the staging unit based carrier truck. By way of example, as depicted in FIG. 3, the staging unit 107 may decide to allocate a vehicle 1071 or a delivery robot 1072 for delivery to specific address location. The staging unit also provides a space wherein the goods for delivery/pick up can be segregated according to pre-defined classifications. By way of example, visual segregation is provided by color coded racks or trays may be provided to hold goods according to destination (as illustrated in FIG. 5 and described in detail subsequently). In a preferred embodiment, one spider is associated with one spider web and one staging unit for efficient work management.

The Spider Delivery System in accordance with the present invention comprises: a plurality of authorized geographically pre-designated spiders, registered with one or more shipping companies, a plurality of sub-spiders associated with a given spider, an authorized staging unit corresponding to the registered spider, and operated by the registered spider, wherein the registered spider is in communication with a shipping company through a software application, the shipping company approves staging unit of the spider, thereby the spider is located at a predefined location and pre-designated time, the spider being associated with one pre-defined dynamically configured geographical route, the shipping company delivers goods/parcels to the spider via one or more carrier truck/vehicle of the shipping company, the spider delivers to pre-specified locations by means of own vehicle, or delivery robots, or drones, through the associated pre-defined dynamically configured route, and updates the status of deliveries and pick up of goods in real time through the smart phone app.

The functioning of a main embodiment of the present invention is presently described. A shipping company intending to use the system for efficient last mile delivery and pick up of goods operates a software application (Carrier System) wherein a user can be registered as an authorized spider, on qualification of specific criteria (“Spider Software System”). A spider is designated handle the delivery and pick up of goods to one or more spider web and interacts with the Spider Software System by way of Spider App installed on his smart device. Depending on the volume of goods to be shipped to a given geographical area, the Spider Software System application allocates deliveries of goods to a given spider as per a designated spider web. The carrier truck of the shipping company delivers the allocated goods to a spider, who is stationed at a pre-specified location at a predetermined time. The Spider App is in continuous communication with the shipping company and accordingly the latest status regarding deliveries is updated in the Spider Software System.

The present invention also provides a method for last mile delivery and pick up of goods from pre-specified locations. The method comprising:
a) registering a spider on a shipping company network after successful validation
b) approving a staging unit to be operated by a registered spider at a predefined location and pre-designated time based on business rules,
c) delivery or pick up of goods from/to a spider via one or more carrier truck/vehicle,
d) localized delivery or pick up of goods from/to addressee location by a spider's local means via one or more sub-spiders, and
e) updation of delivery and pick up status through a software application.

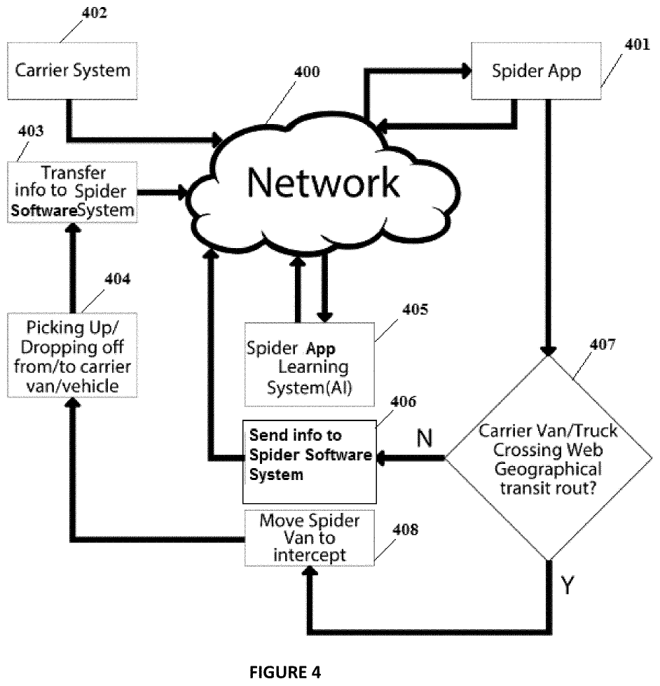

In an alternate embodiment of the present invention, as illustrated in FIG. 4, artificial intelligence based inputs are integrated with the Spider App via as well as a separate software system that caters to the shipping company, designated as a Carrier System. Internet cloud 400 is connected to the Carrier system 402 as well as Spider App 401. Artificial intelligence based software application, designated as Spider App Learning system 405 is also connected to the internet cloud 400. The Spider App 401 determines whether the carrier van is crossing a given geographical route, in the decision step 407. This information is made available to the Spider App through GPS based location tracking data passed on from the Carrier system. Accordingly, the Spider vehicle is moved to the location nearest to the carrier van, at step 408. Subsequently at step 404, transfer of goods from the carrier van to the spider vehicle takes place. This information is then updated in the Spider App through step 403. If the carrier van is not in the vicinity, then the information is passed to the Spider App via step 406. The data related to the location of the carrier van at a typical time, is fed to the Spider learning and prediction system 405, for future prediction of routes.

Referring to FIG. 5, where an exemplary embodiment of the present invention is depicted. A spider vehicle 102 is characterized by a bar coded, distinct unique identification tag 1021. A plurality of color coded trays or baskets are provided for segregation and classification of goods as per required delivery. It is to be understood that color coding is merely exemplary. Any type of classification based on shape, size, weight, nature or position of the goods or the like may be employed. The classification method is not limited to visual segregation methods.

Accordingly, in alternate embodiment of the invention, color coding based visual segregation method is used in staging units to store the goods.

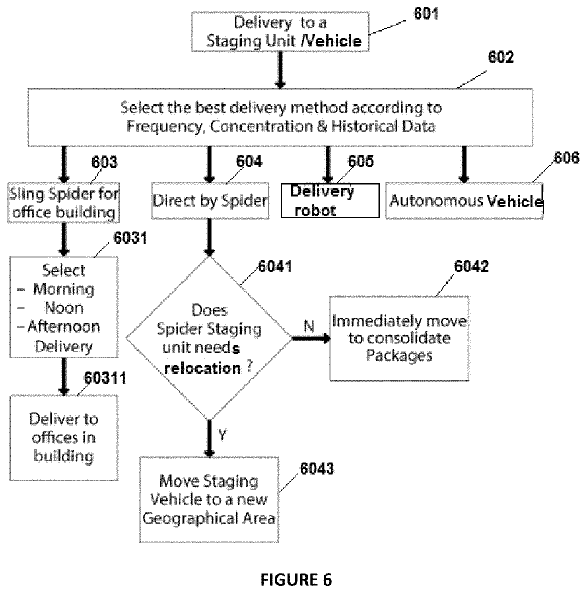

Referring to FIG. 6, which represents a flowchart depicting the functional features of the artificial intelligence based logic used in the system. At step 601, delivery to the staging unit of the spider vehicle is carried out. At step 602, the optimum delivery method is established based on historic data of frequency and distribution of delivery and pick up of goods. Accordingly, steps 603, 604, 605 or 606 may be chosen. Step 603, designated as sling-spider, is selected for deliveries to commercial locations or offices. At step 6031, the time of delivery is preselected and 60311, delivery to the office location is carried out. Step 604 is used for deliveries that are carried out directly by the Spider vehicle. At step 6041, it is determined whether the spider staging unit needs to be relocated. Accordingly at step 6043, the staging unit is moved to a new location while at step 6042, the goods are consolidated for delivery. Step 605 is used for deliveries carried out by delivery robot while step 606 is used for deliveries carried out by autonomous vehicle.

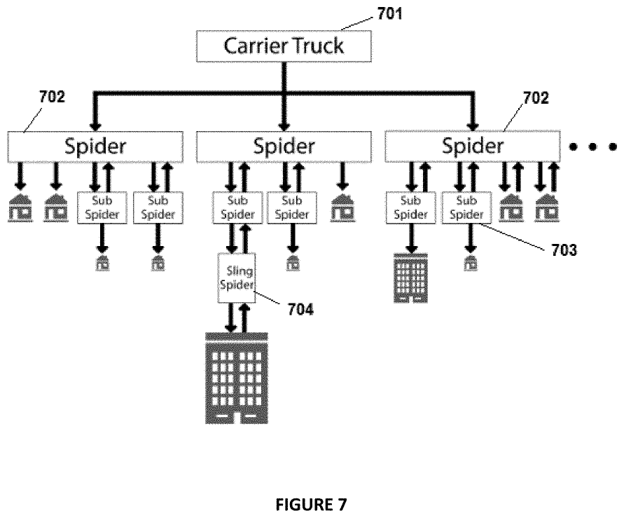

Referring to FIG. 7, the sequence of steps is depicted in an embodiment of the invention. A carrier truck 701 delivers goods/packages to a plurality of spiders 702, positioned at pre-specified geographical locations. A spider 702 may either deliver the goods on their own directly, or may use a sub-spider 703 or local delivery agents, or a sling spider 704 to deliver goods to specific addresses.

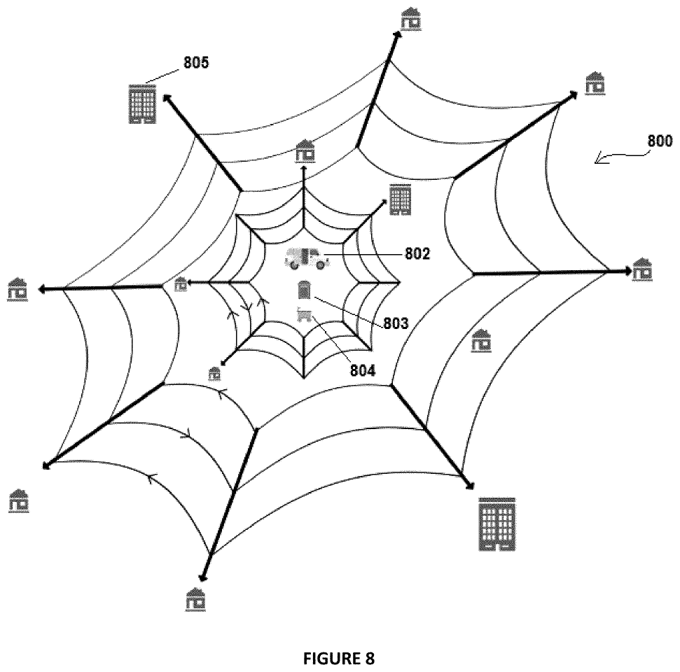

Referring to FIG. 8, which depicts an alternate embodiment of the present invention, designated as the “no address delivery system”. This system acts as a multi dimensional delivery system. This is based on Al based software inputs wherein the based on historical data, the delivery of goods to pre-determined intervals is anticipated. This embodiment is applicable when the number of packages and size of the package is limited. The Spider Software System and its sub-system, Spider App Learning System, collects data from vendors/suppliers on the frequency of certain products that get delivered to a certain address or spider web designated geographical area, for example, a product being regularly supplied to a given address, say, pet food for dogs. The vendor/supplier ships one or a few small units, already packaged, to the spider staging area without the destination address. When the customer orders that particular product, the spider prints the shipping address and delivers it immediately and updates the Spider Software System via the Spider App and in turn the Spider Software System feeds info back to the vendor/supplier on status. This embodiment drastically cut down the shipping time.

Thus in alternate embodiments, the address of goods to be delivered is shipped by the shipping company without a destination address, and the delivery is anticipated based on historical data and predicted as per past delivery frequency.

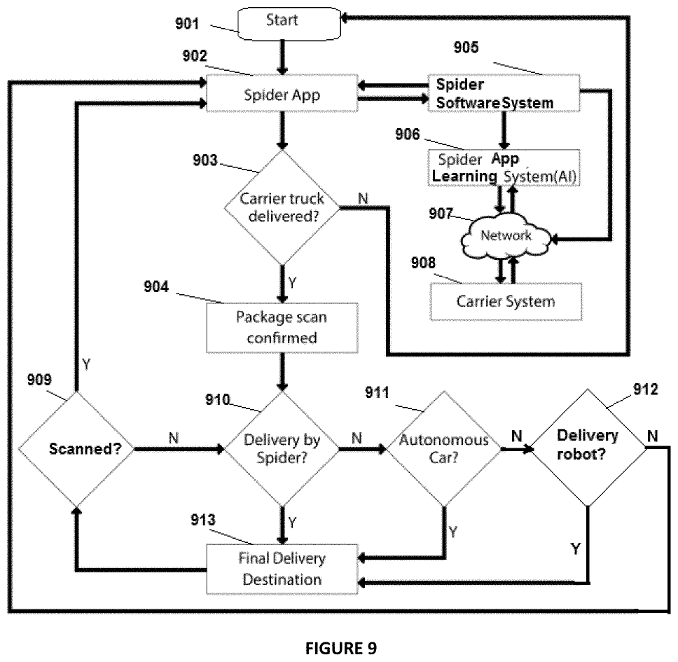

Referring to FIG. 9, which provides an overview of the sequence of steps followed in a main and preferred embodiment of the invention. At step 901, a spider starts the process. The spider uses the Spider App installed in his smart device at step 902. The Spider App 902 is in communication with the Spider Software System 905 and also the internet cloud network 907. The artificial intelligence (AI) based Spider App Learning System 906 is also coupled to the Spider Software System 905 as well as the internet cloud network 907. The Carrier System 908 is connected to the internet cloud network 907. At step 903, it is determined whether the delivery by the carrier vehicle has taken place. If the delivery has taken place, then at step 904, the package is scanned. At step 910, it is determined whether the delivery is to be executed by the spider. If yes, then at step 913, the package is delivered. Subsequently at step 909, the delivery note is scanned for updation. If the delivery is not to be done by the spider, then at step 911, it is determined if the delivery is to be done by an autonomous vehicle, and at step 912, it is determined if the delivery is to be done by a delivery robot. If delivery is performed using autonomous vehicle or delivery robot, then after package delivery at step 913, the delivery note is scanned at step 909.

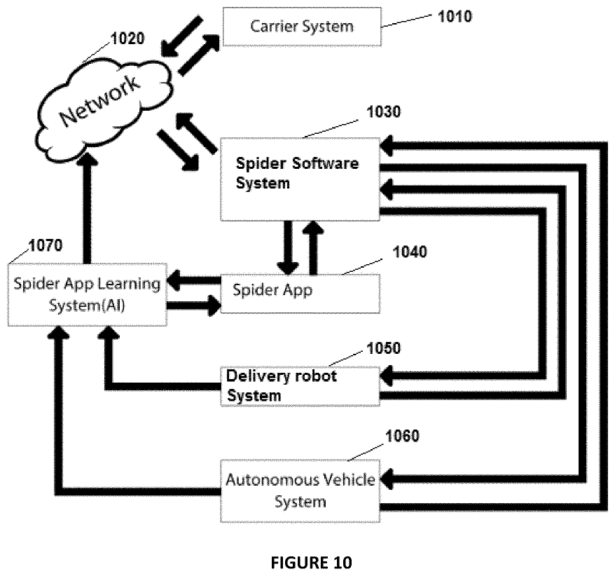

Referring to FIG. 10, which is an illustration depicting the information flow among various software modules/applications used in a preferred embodiment of the Spider Delivery System. The Carrier System 1010, the Spider Software System 1030 and the Spider App Learning System 1070 are in communication with the internet cloud network 1020. The Spider App 1040 is in communication with the Spider Software System 1030 and the Spider App Learning System 1070. The Delivery robot System 1050, and the Autonomous Vehicle System 1060 are in communication with the Spider Software System 1030 as well as the Spider App Learning System 1070.

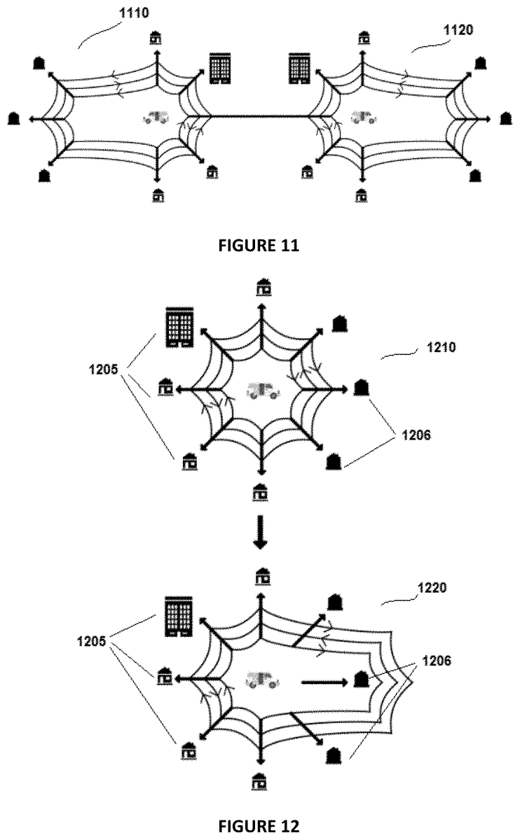

Referring to FIG. 11, which denotes an embodiment of the invention (designated as the “intelligent splitting system”) wherein when the volume of package delivery increase for a certain web, the Spider App Learning system splits that spider web into two spiders webs and therefore two spiders, to keep the delivery efficient. So, the web system is always dynamically organized to manage the increased delivery work flow without compromising on delivery time efficiency. As depicted in FIG. 11, two spider webs 1110 and 1120 are created by splitting a single spider web. It is to be noted that splitting into two spider webs is merely exemplary in nature.

Accordingly, in an alternate embodiment intelligent splitting of spider webs takes place as per volume of deliveries such that a single spider web is divided into two or more spider webs, to maintain the delivery time within pre-specified limit, in case the volume of deliveries is large.

Similarly, in alternate embodiments, in case of low volume of deliveries, two spider webs may be merged into one, for optimum resource management.

Referring to FIG. 12, the Spider App Learning system keeps adjusting the spider area and moves the staging unit to accommodate faster for faster delivery. 1210 depicts a conventional spider web, with deliveries scheduled for destination locations 1205 and frequent delivery destination locations 1206. 1220 depicts the reconfigured spider web, wherein proximity to frequent delivery destinations 1206 is considered.

Accordingly, an alternate embodiment of the system includes Artificial Intelligence based software inputs are used for predicting frequent destinations and paths for delivery by the spider.

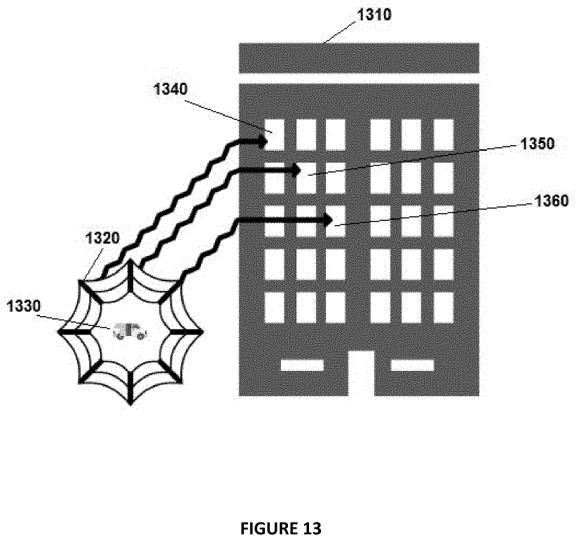

Referring to FIG. 13, which depicts a sling-spider, an embodiment of the invention used for delivery to office locations. In this embodiment, a person who is working in the same premises or is in proximity to a specified office or commercial location works as a spider and uses his/her own vehicle as a spider vehicle. A sling spider get assigned to one specific business office, office building, or commercial building, denoted by 1310, associated with a spider web 1320. The person usually works for a company in that building or has a place of doing business in that building. Spider or sub-spider delivers packages to his car in a parking lot or in a staging box, designated as 1330, positioned in proximity to the business location 1310. A sling-spider delivers packages before the start of business (usually early morning), during a break/recess or during lunch-break. The deliveries happen to different destinations 1340, 1350 and 1360 all of which are located within the same commercial space 1310. Sling-spider's vehicle or staging unit are managed and operated in the same way as that of a spider or a sub-spider.

Accordingly in an alternate embodiment of the invention, a system for efficient last mile delivery of goods to commercial office and business location, includes a sling-spider, i.e. a person having a place of work in the same commercial business location or in proximity to the commercial business location, who delivers goods during a break or in recess.

Even though numerous characteristics and advantages of the present invention have been set forth in the foregoing description, together with details of the structure and function of the invention, the disclosure is illustrative only. Changes may be made in detail, especially in matters of business rules within the principles of the invention to the full extent indicated by the broad general meaning of the terms in which the appended claims are expressed.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A system for delivery of goods from a shipping company to pre-specified locations comprises:
a) a plurality of authorized geographically pre-designated spiders, registered with one or more shipping companies,
b) a plurality of sub-spiders associated with a given spider,
c) an authorized staging unit corresponding to the registered spider,
wherein a registered spider is in communication with a shipping company through a software application,
the shipping company approves staging unit of the spider, thereby the spider is located at a predefined location and pre-designated time,
the spider being associated with one pre-defined dynamically configured geographical route,
the shipping company delivers goods to the spider via one or more carrier vehicle of the shipping company, the spider delivers to pre-specified locations by means of own vehicle, or delivery robots, or drones, through the associated pre-defined dynamically configured route, and updates the status of deliveries and pick up of goods in real time through the software application.

2. A system as claimed in claim 1, wherein the software application comprises the modules: a Carrier System, a Spider Software System, a Spider App Learning System and a Spider App, wherein the software modules are in communication with each other via internet cloud in real time.

3. A system as claimed in any of the claim 1 or 2, wherein Artificial Intelligence based software inputs are used for predicting frequent destinations and paths for delivery by the spider.

4. A system as claimed in any of the claims 1 to 3, wherein color coding based visual segregation method is used in staging units to store the goods.

5. A system as claimed in any of the claims 1 to 4, wherein intelligent splitting of spider webs takes place as per volume of deliveries such that a single spider web is divided into two or more spider webs, to maintain the delivery time within pre-specified limit.

6. A system as claimed in any of the claims 1 to 5, wherein a sling-spider is used for deliveries in a commercial business location such that the sling-spider has a place of work in the same commercial business location or in proximity to the commercial business location.

7. A system as claimed in any of the claims 1 to 6, wherein the address of goods to be delivered is shipped by the shipping company without a destination address, and the delivery anticipated based on historical data and predicted as per past delivery frequency.

8. A method for last mile delivery and pick up of goods from pre-specified locations comprising:
a. registering a spider on a shipping company network after successful validation
b. assigning a staging unit to a registered spider to a predefined location and pre-designated time based on business rules,
c. delivery or pick up of goods from/to a spider via one or more carrier truck/vehicle,
d. localized delivery or pick up of goods from/to addressee location by a spider's local means via one or more sub-spiders, and
e. updation of delivery and pick up status through a software application.
